(19) United States
(12) Patent Application Publication
(10) Pub. No.: US 2022/0306290 A1
(43) Pub. Date: Sep. 29, 2022

(54) CONTROL SYSTEM FOR CONTROLLING AT LEAST ONE PROPELLER OF A COMPOUND ROTORCRAFT, ASSOCIATED COMPOUND ROTORCRAFT AND CONTROL METHOD

(71) Applicant: AIRBUS HELICOPTERS, Marignane Cedex (FR)

(72) Inventor: Kamel ABDELLI, Marseille (FR)

(73) Assignee: AIRBUS HELICOPTERS, Marignane Cedex (FR)

(21) Appl. No.: 17/673,043

(22) Filed: Feb. 16, 2022

(30) Foreign Application Priority Data
Mar. 26, 2021 (FR) 2103064

(51) Int. Cl. B64C 27/72; B64C 27/26; B64C 27/24; B64C 27/56

(52) U.S. Cl. CPC B64C 27/72; B64C 27/26; B64C 27/24; B64C 27/56

(57) ABSTRACT

A control system for controlling at least one propeller of a compound rotorcraft, the control system generating a control order for collectively controlling a pitch of the blades of at least one propeller. According to the disclosure, the control system comprises: a first piloting control for generating a first control setpoint; a second piloting control for at least generating a second control setpoint different from first control setpoint; and a control unit configured to generate control order depending on the first control setpoint and second control setpoint, the control unit implementing a control law generating the control order as a function of first control setpoint and the second control setpoint.

### CROSS REFERENCE TO RELATED APPLICATIONS

This application claims the benefit of FR 21 03064 filed on Mar. 26, 2021, the disclosure of which is incorporated in its entirety by reference herein.

### TECHNICAL FIELD

The present disclosure relates to a control system for controlling at least one propeller of a compound rotorcraft or a compound helicopter.

### BACKGROUND

Such a compound rotorcraft can thus be equipped with such a control system and implement an associated control method.

This type of control system makes it possible, in particular, to generate a control order for collectively controlling a pitch of the blades of one or more propellers.

In general, a rotorcraft such as a helicopter may conventionally comprise a main rotor and also a yaw movement control rotor.

In order to pilot a helicopter, a pilot can operate a first control and a second control for respectively controlling, collectively and cyclically, the pitch of the blades of the lift rotor, for example via a mechanical and/or electrical architecture. The first control is referred to, for convenience, as the “collective pitch control”, and is often in the form of a lever referred to as the “collective pitch lever”. The second control is referred to, for convenience, as the “cyclic pitch control” and is often in the form of a stick referred to as the “cyclic stick”.

Another type of rotorcraft may be referred to, for convenience, as a “compound rotorcraft”, owing to its specific nature. A compound rotorcraft has an airframe carrying at least one rotary wing provided with a rotor, this rotor being referred to hereinafter, for convenience, as a “lift rotor”, due to at least one function that it performs. The lift rotor helps at least provide lift for the aircraft, and indeed can also help propel it forward.

A compound rotorcraft further includes at least one propeller, possibly of the tractor or pusher propeller type. For example, the compound rotorcraft may be provided with at least two propellers arranged transversely to either side of the fuselage. Each propeller is carried by a support that may be in the form of a wing.

Furthermore, a compound rotorcraft includes a power plant for setting in motion each propeller and/or the lift rotor, optionally continuously except in the event of failure or during testing.

In addition to the first control and the second control mentioned above, such a compound rotorcraft is provided with controls for controlling the propeller or propellers.

In particular on a compound rotorcraft having at least two propellers situated to either side of the fuselage, the pitch of the blades of each propeller is a function of a mean pitch component and a differential pitch component. Thus, the first pitch of the first blades of a first propeller may be equal to the sum of the mean pitch component plus the differential pitch component while the second pitch of the second blades of a second propeller may be equal to the mean pitch component minus the differential pitch component. Furthermore, the mean pitch component may be equal to the half-sum of the first and second pitches of the two propellers while the differential pitch component may be equal to the half-difference between the first and second pitches of the two propellers.

Consequently, a compound rotorcraft includes at least one thrust control suitable for modifying the value of the mean pitch component, for example via a mechanical and/or electrical architecture.

Examples of compound rotorcraft are described, for example, in documents U.S. Pat. Nos. 8,181,901, 8,170,728, 8,052,094, and 8,113,460.

On a conventional helicopter equipped only with a main rotor and a yaw movement control rotor, the air speed of the aircraft is controlled by modifying the pitch attitude of this aircraft. This pitch attitude is itself controlled by controlling the cyclic pitch of the main rotor blades. In order to keep the rotorcraft at the same altitude, the collective pitch of the main rotor blades is also controlled. By way of illustration, in order to increase the air speed of the aircraft, the pilot modifies the cyclic pitch of the main rotor blades in order to cause the nose of this aircraft to pitch down. In order to prevent the aircraft from following a downward trajectory, the pilot simultaneously increases the collective pitch of the main rotor blades.

On a compound helicopter equipped with propellers carried by a wing, a pilot may proceed in the same manner. However, the pilot may alternatively increase the air speed while holding altitude by controlling the thrust generated by the propellers and by decreasing the collective pitch of the main rotor blades.

The controls available to a pilot in a compound helicopter may take various forms.

The aircraft may thus include a movable thrust control controlling a modification in the pitch of the propeller blades in pitch degrees per second. Each position of the thrust control corresponds to a modification in the pitch of the propeller blades in pitch degrees per second.

According to another possibility, the aircraft may include a movable thrust control permanently generating a control signal carrying a control setpoint. This control setpoint is converted into a pitch setpoint.

Documents WO 2016/043942 and WO 2016/043943 describe a pitch control system configured to vary a pitch angle of a plurality of blades of a rotorcraft propeller. The control system includes a motor having a motor shaft configured to rotate about an axis. A rotary switch including a tab is coupled to the motor shaft and is configured to move between a first position and a second position. The pitch control system also includes a position sensor configured to control the position of the rotary switch. The position of the rotary switch is proportional to the pitch angle of the plurality of blades of the propeller.

According to another example, a thrust control may comprise a knob having at least three discrete states, namely a first state referred to as “beep+” requesting an increase in the value of the mean pitch component, a second state referred to as “beep−” requesting a decrease in the value of the mean pitch component, and a third state requesting no modification of the value of the mean pitch component. The pitch of the blades of the propellers is thus increased as long as a pilot positions the knob in its first state.

Alternatively, it is also known that such a beep+ and beep− control can allow a position deviation control or a temporary speed deviation control to be implemented.

According to another embodiment of the thrust control of a compound rotorcraft, a thumbwheel that can be moved according to at least one degree of freedom relative to a support may generate a control signal that is a function of the current position of the control member along its travel path.

Document EP 3 503 149 A1 describes an electrical control mechanism (1) provided with a support (5). A central body (10) that is able to rotate about a central rotation axis (AXROTC) carries a knob (3) that is able to rotate relative to the central body (10) about an offset rotation axis (AXROTD) parallel to the central rotation axis (AXROTC).

A first return means (20) is interposed between the central body (10) and the knob (3), a second return means (23) being interposed between the central body (10) and the support (5). Two primary electric switches (31, 34) are interposed between the knob (3) and the central body (10) to either side of a plane (100) containing said central rotation axis (AXROTC) and the offset rotation axis (AXROTD). Two secondary electric switches (41, 44) are interposed between the support (5) and the central body (10) to either side of the plane.

In addition, a computer can generate a control order for collectively controlling a pitch of the blades of at least one propeller depending on the first control setpoint and the second control setpoint. Documents EP 2 258 616 and US 2018/319482 describe other control systems for controlling a compound rotorcraft according to the technological background of the disclosure.

### SUMMARY

An object of the present disclosure is to propose an alternative control system that makes it possible to provide different levels of sensitivity for the thrust control of a compound rotorcraft propeller. The disclosure thus allows the pilot to reach any type of piloting target with a very precise setpoint.

The disclosure therefore relates to a control system for controlling at least one propeller of a compound rotorcraft, the control system generating a control order for collectively controlling a pitch of the blades of the at least one propeller, such a system including:

a first piloting control for generating a first control setpoint;

a second piloting control for at least generating a second control setpoint different from the first control setpoint; and

a control unit configured to generate the control order depending on the first control setpoint and the second control setpoint, the control unit implementing a control law generating the control order as a function of the first control setpoint and the second control setpoint.

According to the disclosure, such a system is remarkable in that the first control setpoint is representative of a first control parameter and the second control setpoint is representative of a second control parameter corresponding to a primitive of the first control parameter.

In other words, the control order is generated by combining two different control setpoints produced by two piloting controls separate from each other. The first and second piloting controls can also be actuated individually with respect to each other and alternately relative to each other.

Indeed, such first and second piloting controls are capable of being actuated one after another by a finger such as the thumb or the index finger of a given hand of a pilot.

The pilot can thus actuate the first control in order to generate a first setpoint aimed at modifying the control order with a first level of precision or sensitivity in order to approach a predetermined piloting target. Once close to the piloting target, the pilot then actuates the second control in order to generate a second setpoint allowing the control order to be modified with a second level of precision or sensitivity in order to reach the predetermined piloting target. The second level of precision is therefore greater than the first level and allows the pilot to reach the piloting target.

The first and second controls are thus connected by wired or wireless means to the control unit that receives the first and second control setpoints.

These first and second control setpoints are then processed and optionally stored by the control unit in order to then be able to generate the control order allowing the compound rotorcraft to reach the predetermined piloting target in a precise manner. The control order can thus be modified in a differentiated manner according to two different increments comprising a first increment provided by the first control setpoint and a second increment provided by the second control setpoint.

The first increment is greater than the second increment and thus allows the pilot to rapidly modify the control order with a large increment.

The second increment is therefore chosen to be smaller than the first increment and thus makes it possible to reach a predetermined piloting target in a precise manner.

The control unit may, for example, comprise at least one processor and at least one memory, at least one integrated circuit, at least one programmable system, at least one logic circuit, these examples not limiting the scope given to the expression “control unit”. The term “processor” may refer equally to a central processing unit (CPU), a graphics processing unit (GPU), a digital signal processor (DSP), a microcontroller, etc.

In other words, when the first control generates a first setpoint representative of an acceleration of the compound rotorcraft, the second control generates a second setpoint representative of a speed of the compound rotorcraft. Similarly, when the first control generates a first setpoint representative of a jerk of the compound rotorcraft, the second control generates a second setpoint representative of an acceleration of the compound rotorcraft.

Advantageously, the first piloting control may include a first movable member having at least one degree of rotational mobility relative to a first support about a first rotation axis, said first movable member being capable of being rotated in two opposing directions of rotation about a first central position.

In other words, the first movable member is articulated in such a way as to be able to rotate relative to a first support about a pivot connection. The first movable member may thus comprise, for example, a thumbwheel having a textured surface, provided with studs, knurled or indeed notched. Alternatively, the first movable member may comprise a knob having a protrusion that projects substantially perpendicular to the first rotation axis.

In practice, the first piloting control may be monostable, the first piloting control including first elastic return means configured to return the first movable member to the central position.

Moreover, the first control may make it possible to generate an analog output signal for continuously varying the first control setpoint.

Having approached a piloting target by means of the first control setpoint, the pilot can then optionally release the first movable member, which then automatically returns to its central position. The first elastic return means may in particular comprise at least one spring under torsion, compression and/or traction.

According to one embodiment of the disclosure, the second piloting control may include a second movable member having at least one degree of rotational mobility relative to a second support about a second rotation axis, the second movable member being capable of being rotated in two opposing directions of rotation about a second central position.

Thus, as previously for the first control, the second movable member is articulated so as to be able to rotate relative to a second support about a pivot connection. The second movable member may thus comprise, for example, a thumbwheel having a textured surface, provided with studs, knurled or indeed notched. Alternatively, the second movable member may comprise a knob or a concave face having a protrusion that projects radially relative to the second rotation axis.

Such a knob may have at least three discrete states, namely a first state referred to as “beep+” requesting an increase in the second control setpoint, a second state referred to as “beep−” requesting a decrease in the second control setpoint, and a third state requesting no modification of the second control setpoint.

The beep+ first state thus corresponds to a movement of the second movable member in a first direction of rotation.

The beep− second state corresponds to a movement of the second movable member in a second direction of rotation opposite the first direction of rotation.

In practice, the second piloting control may be monostable, the second piloting control including second elastic return means configured to return the second movable member to the second central position.

Once the piloting target has been reached by means of the second control setpoint, the pilot releases the second movable member that then automatically returns to its central position. The second elastic return means may in particular comprise at least one spring under torsion, compression and/or traction.

Applying pressure to the second movable member according to the degree of mobility about the second rotation axis may thus increment or decrement the control order by a predetermined increment, allowing the pitch of the blades of the at least one propeller to be collectively controlled.

Advantageously, the second movable member may have a degree of translational mobility relative to the second support along a translation axis, the translation axis being oriented perpendicular to the second rotation axis.

In other words, the second movable member may have a function ancillary to the modification of the second control setpoint. This ancillary function may make it possible to select or activate a particular control mode by applying pressure to the second movable member according to its degree of translational mobility and along the translation axis.

According to an alternative of the disclosure compatible with the above, the first control setpoint may be representative of a first control parameter chosen from the group comprising a ground speed of the compound rotorcraft, an air speed of the compound rotorcraft, a longitudinal acceleration of the compound rotorcraft relative to the ground, a first time derivative of the longitudinal acceleration of the compound rotorcraft relative to the ground, a second time derivative of the longitudinal acceleration of the compound rotorcraft relative to the ground, a speed of variation of a power transmitted to the at least one propeller, a speed of variation of the pitch of said blades of the at least one propeller.

In practice, the first control setpoint may thus be generated by modifying the first control parameter by a first predetermined or non-predetermined increment. Thus, when the first piloting control comprises a first movable member having at least one degree of rotational mobility relative to a first support about a first rotation axis, actuation of the first piloting control according to this degree of rotational mobility relative to the first support can generate the first control setpoint, for example in the form of an analog signal representative of the first control parameter.

On the other hand, the second piloting control including a second movable member having at least one degree of rotational mobility relative to a second support about a second rotation axis, pulsed actuation of the second piloting control according to the at least one degree of rotational mobility relative to the second support can generate the second control setpoint in the form of a calibrated signal representative of the second control parameter. The second control setpoint can thus be used to modify the control order precisely by a predetermined increment.

Additionally, or alternatively, the second control setpoint can be generated by integrating the variations of the first control parameter over a time interval defined by a duration of actuation of the second piloting control.

Thus, an electronic clock or a counter can be used to count the duration of actuation of the second piloting control. This duration of actuation can then be used to reach the piloting target more or less quickly.

Advantageously, the first control setpoint may be representative of a first control parameter determined according to a choice from at least two different control parameters; an actuation of the second piloting control may be configured to modify the choice of the first control parameter.

Such an actuation of the second control may be achieved, for example, by moving the second movable member according to its degree of rotational mobility about the second rotation axis. A display device such as a screen makes it possible, for example, to display the control parameters alternately or else to display the choice of the parameter, for example by changing its color, framing it or highlighting it.

According to another embodiment of the disclosure compatible with the preceding embodiments, since the second movable member has a degree of translational mobility relative to the second support along a translation axis, moving the second movable member along the translation axis may modify the choice of the first control parameter.

In other words, moving the second control in translation along the translation axis may enable a pilot to validate or select the choice of the first control parameter previously made by manoeuvring the second movable member according to its degree of rotational mobility about the second rotation axis.

In practice, the first piloting control and the second piloting control may be arranged on a handle of a collective pitch control stick, the collective pitch control stick enabling to collectively control a pitch of the blades of a lift rotor of the compound rotorcraft.

In other words, the first piloting control and the second piloting control may be actuated by one or more fingers of a hand of a pilot holding the collective pitch control stick in the palm of his or her hand.

According to one advantageous embodiment, the first piloting control and the second piloting control may be separate from each other.

In other words, the first piloting control and the second piloting control may be actuated individually and independently of each other. The first piloting control can thus be operated by a pilot without actuating the second piloting control and, conversely, the second piloting control can be actuated without actuating the first piloting control.

The first piloting control and the second piloting control can, for example, be juxtaposed side by side on the handle of the collective pitch control stick for collectively controlling the pitch of the blades of the lift rotor of the compound rotorcraft.

Moreover, the disclosure also relates to a compound rotorcraft including at least one propeller.

Such a rotorcraft is remarkable in that it includes the abovementioned control system allowing a control order to be generated and transmitted to the propeller or propellers.

The object of the present disclosure is also a control method for controlling at least one propeller of a compound rotorcraft, the control method including a step of generating a control order for collectively controlling a pitch of the blades of the at least one propeller, such a control method comprising the following steps:

generating a first control setpoint; and

generating a second control setpoint different from the first control setpoint,

the step of generating the control order being carried out depending on the first control setpoint and the second control setpoint, by implementing a control law generating the control order as a function of the first control setpoint and the second control setpoint.

According to the disclosure, such a method is remarkable in that the first control setpoint is representative of a first control parameter and the second control setpoint is representative of a second control parameter corresponding to a primitive of the first control parameter.

Thus, the control method helps facilitate the piloting of a compound rotorcraft by generating a control order by means of the two different control setpoints produced by two piloting controls that are separate from each other. The first and second control setpoints are further generated individually, one after the other, enabling a pilot to reach a predetermined piloting target in a quick and precise manner.

### BRIEF DESCRIPTION OF THE DRAWINGS

The disclosure and its advantages appear in greater detail in the context of the following description of embodiments given by way of illustration and with reference to the accompanying figures, in which:

FIG. 1 is a perspective view of a compound rotorcraft according to the disclosure;

FIG. 2 is a front view of a handle of a collective pitch control stick;

FIG. 3 is a transverse cross-sectional view of a first piloting control;

FIG. 4 is a transverse cross-sectional view of a second piloting control; and

FIG. 5 is a logic diagram showing a control method according to the disclosure.

### DETAILED DESCRIPTION

Elements that are present in more than one of the figures are given the same references in each of them.

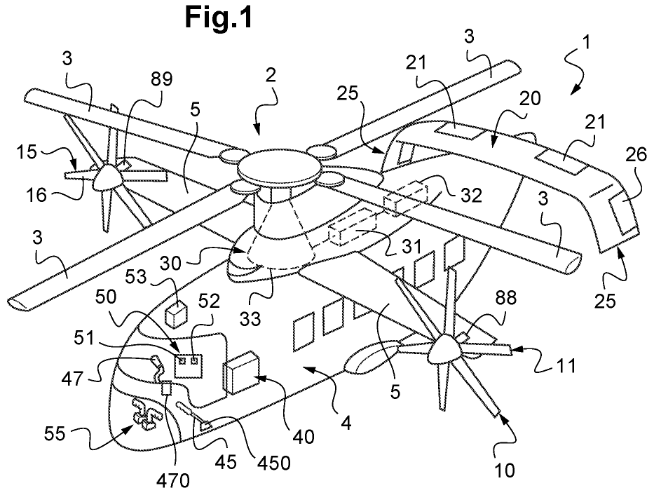

FIG. 1 shows a compound rotorcraft 1 according to the disclosure.

This compound rotorcraft 1 has a fuselage 4 above which at least one lift rotor 2 is arranged. This lift rotor 2 is provided with a plurality of blades referred to for convenience as “main blades 3”.

In addition, the compound rotorcraft 1 is provided with at least one propeller referred to as the “first propeller”, of the tractor or pusher type. For example, the compound rotorcraft 1 is provided with at least one first propeller 10 and with at least one second propeller 15. The first and second propellers 10, 15 respectively have a plurality of first blades 11 and a plurality of second blades 16. The first propeller 10 and the second propeller 15 may be arranged laterally relative to the fuselage 4, in particular to either side of an anteroposterior plane of the compound rotorcraft 1. In FIG. 1, the first and second propellers 10, 15 are interchangeable. The first and second propellers 10, 15 are optionally carried by a support 5. Such a support 5 may optionally be aerodynamic. For example, the support 5 comprises a wing as shown in FIG. 1. In FIG. 1, the propellers 10, 15 are arranged at the leading edge of a wing. According to another example, the propellers 10, 15 may be arranged at the trailing edge of the wing.

Furthermore, the compound rotorcraft 1 may include stabilizer or indeed manoeuvring surfaces. For example, for fore-and-aft control, the compound rotorcraft 1 may include at least one substantially horizontal empennage 20, optionally provided with movable elevators 21. For example, for directional stability and control, the compound rotorcraft 1 may include at least one substantially vertical empennage 25, optionally provided with movable rudders 26. FIG. 1 thus shows a tail assembly in an upside-down U shape, but this tail assembly may have various shapes without going beyond the ambit of the disclosure. According to another example, the tail assembly may be H-shaped, U-shaped, etc. The teaching of patent FR 3 074 142 is also applicable, for example.

Furthermore, the compound rotorcraft 1 includes a power plant 30 for delivering power to the lift rotor 2 and optionally to each propeller 10, 15. For this purpose, the power plant 30 includes at least one engine 31 that is controlled by a standard engine computer 32.

The term “computer” is used hereinafter to refer to a unit that may, for example, comprise at least one processor and at least one memory, at least one integrated circuit, at least one programmable system, at least one logic circuit, these examples not limiting the scope given to the expression “computer”. The term “processor” may refer equally to a central processing unit (CPU), a graphics processing unit (GPU), a digital signal processor (DSP), a microcontroller, etc.

In addition, the power plant 30 may include, for example within an interconnection system, at least one gearbox, at least one shaft, and/or at least one member for interconnecting two members in rotation, etc. For example, one or more engines 31 are connected mechanically by one or more mechanical connection systems to a main gearbox 33 that rotates the lift rotor 2. Furthermore, the main gearbox 33 may be connected mechanically by at least one shaft to one lateral gearbox per propeller 10, 15, which lateral gearbox is then connected in turn to a propeller 10, 15.

The speeds of rotation of the outputs of the engine or engines 31, of the propellers 10, 15, of the lift rotor 2, and of the mechanical interconnection system are optionally proportional to each other, the proportionality ratio optionally being constant regardless of the flight configuration of the compound rotorcraft 1 under normal operating conditions, i.e., except in the event of failure or during testing or training.

Furthermore, the compound rotorcraft 1 may include various controls in order to be piloted.

In particular, the compound rotorcraft 1 may include a piloting system 40 connected to flight controls for collectively and cyclically controlling the pitch of the main blades 3. Such a piloting system 40 may, for example, include a set of swashplates. Thus, at each instant, the pitch of the main blades 3 may be equal to the sum of a collective pitch that is identical for all of the main blades 3 and a cyclic pitch that varies as a function of the azimuth of each main blade 3. The pitch of the main blades 3 is referred to as the “main pitch” so as to be clearly distinguished from the pitches of the other blades.

The compound rotorcraft 1 may therefore include a collective pitch control 45 that can be operated by a pilot who acts on at least one mechanical and/or electrical control channel of the piloting system 40 in order to cause the main pitch of the main blades 3 to vary collectively, where applicable via the set of swashplates. For example, the collective pitch control 45 comprises a lever. Moreover, the collective pitch control 45 may comprise a collective pitch sensor 450 that emits an analog, digital, electrical or optical signal that varies as a function of the position of a movable member. For example, the collective pitch control 45 comprises a lever and a collective pitch sensor 450 including at least one angular position sensor for assessing a position of the lever, such as a potentiometer, for example. The collective pitch sensor 450 may also be arranged on a movable member together with the collective pitch control, for example downstream of series actuators and/or trim actuators, as applicable.

Similarly, the compound rotorcraft 1 may include a cyclic pitch control stick 47 that can be operated by a pilot who acts on one or more mechanical and/or electrical control channels of the piloting system in order to cause the pitch of the main blades 3 to vary cyclically, where applicable via the set of swashplates. Moreover, the cyclic pitch control stick 47 may comprise a position sensor 470 that emits an analog, digital, electrical or optical signal that varies as a function of the position of a movable member. For example, the cyclic pitch control stick 47 comprises a stick and a position sensor 470 including at least two angular position sensors for assessing a position of the stick, such as potentiometers, for example.

Typically, the compound rotorcraft 1 may include a control system 50 for controlling the pitch of the blades 11, 16 of the propeller or propellers 10, 15, and, in particular, the pitch of the first blades 11 and the second blades 16, as in the example shown. At each instant, and in particular in the presence of two propellers 10, 15, the first pitch of the first blades 11 of the first propeller 10 may be equal to the sum of a mean pitch component and a differential pitch component, while the second pitch of the second blades 16 of the second propeller 15 is equal to the difference between this mean pitch component and the differential pitch component.

Optionally, the compound rotorcraft 1 includes a first measurement sensor 88 for measuring the first value of the first pitch and a second measurement sensor 89 for measuring the second value of the second pitch. For example, the first measurement sensor 88 includes a position sensor that emits an analog, digital, electrical or optical signal that varies as a function of the position of a control shaft for controlling the pitch of the first blades 11. Similarly, the second sensor 89 may include a position sensor that emits an analog, digital, electrical or optical signal that varies as a function of the position of a control shaft for controlling the pitch of the second blades 16. Each position sensor may be of a usual type and may, for example, comprise a speed sensor for obtaining a position by integration, a potentiometer, etc. Such sensors 88 and 89 may in particular make it possible, with a control loop, to control a control order allowing a pitch of the blades 11, 16 to be collectively controlled.

Typically, a piloting control may be operated by a pilot who acts on one or more mechanical and/or electrical control channels of the piloting system 40 in order to cause the pitch of the propeller or propellers to vary, for example in order to control a forward speed of the compound rotorcraft 1. For example, the piloting control may either control the total pitch of the propeller or propellers or control the value of a mean pitch component, where applicable.

Similarly, the compound rotorcraft 1 may include a yaw control 55 that can be operated by a pilot who that acts on one or more mechanical and/or electrical control channels of the piloting system 40 in order to cause the differential pitch component of the pitch of the first blades 11 and the pitch of the second blades 16 to vary, as applicable. The yaw control 55 may, for example, be in the form of a rudder bar.

Furthermore, the piloting system 40 may include one or more control computers that are in communication at least with a piloting control and optionally also with the first measurement sensor 88, the second measurement sensor 89 and/or the collective pitch sensor 450, or indeed with one or more of the abovementioned controls.

In addition, such a compound rotorcraft also includes a control system 50 for controlling the propeller or propellers 10, 15 by generating a control order for collectively controlling a pitch of the blades 11, 16.

This control system 50 may be separate from or combined with the abovementioned piloting system 40 and may include, for example, an automatic flight control system referred to by the acronym AFCS.

Such a control system 50 also comprises a first piloting control 51 for generating a first control setpoint, and a second piloting control 52 for at least generating a second control setpoint different from the first control setpoint.

The control system 50 comprises a control unit 53 configured to generate the control order depending on the first control setpoint and the second control setpoint.

The control unit 53 thus implements a control law generating the control order as a function of the first control setpoint and the second control setpoint.

The term “control unit” is used hereinafter to refer to a unit that may, for example, comprise at least one processor and at least one memory, at least one integrated circuit, at least one programmable system, at least one logic circuit, these examples not limiting the scope given to the expression “control unit”. The term “processor” may refer equally to a central processing unit (CPU), a graphics processing unit (GPU), a digital signal processor (DSP), a microcontroller, etc.

Furthermore, the first control setpoint is advantageously representative of a first control parameter chosen from the group comprising a ground speed of the compound rotorcraft 1, an air speed of said compound rotorcraft 1, a longitudinal acceleration of the compound rotorcraft 1 relative to the ground, a first time derivative of the longitudinal acceleration of the compound rotorcraft 1 relative to the ground, a second time derivative of the longitudinal acceleration of the compound rotorcraft 1 relative to the ground, a speed of variation of a power transmitted to the at least one propeller 10, 15 and a speed of variation of the pitch of the blades 11, 16 of the at least one propeller 10, 15.

Moreover, the first control setpoint is representative of a first control parameter and the second control setpoint is representative of a second control parameter corresponding to a primitive of the first control parameter.

Moreover, the second control setpoint can be generated by integrating the variations of the first control parameter over a time interval defined by a duration of actuation of the second piloting control 52.

Advantageously, the first control setpoint and the second control setpoint may be generated by means of analog, digital, electrical or optical signals that vary as a function of the position of a movable member.

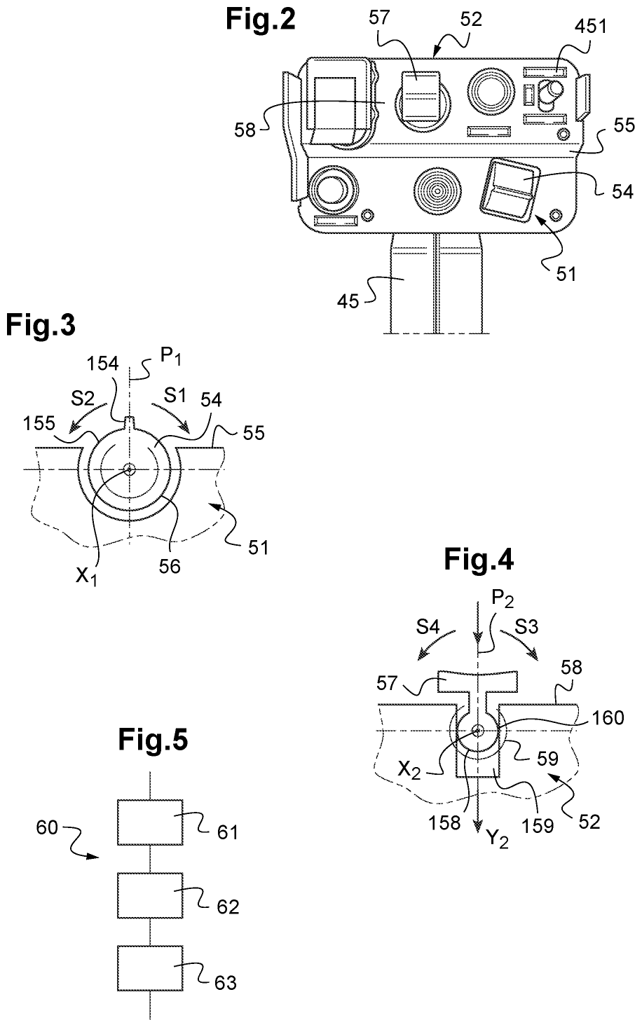

As shown in FIG. 2, the first piloting control 51 and the second piloting control 52 can, for example, be juxtaposed side by side on a handle 451 of the collective pitch control stick 45 for collectively controlling the pitch of the blades of the lift rotor of the compound rotorcraft. Thus, the first piloting control 51 and the second piloting control 52 are separate from each other and can be actuated by a pilot independently of each other.

The first piloting control 51 may, for example, comprise a first movable member 54 capable of moving relative to a first support 55. Thus, the first movable member 54 may have at least one degree of rotational mobility relative to the first support 55 about a first rotation axis X1.

Similarly, the second piloting control 52 may comprise a second movable member 57 having at least one degree of rotational mobility relative to a second support 58 about a second rotation axis X2.

In addition, the first support 55 and the second support 58 may be formed by the same assembly comprising a handle 451 of the collective pitch control stick 45 as described in FIG. 1.

Furthermore, when the first piloting control 51 comprises a first movable member 54 having at least one degree of rotational mobility relative to the first support 55 about the first rotation axis X1, actuation of the first movable member 54 according to its degree of rotational mobility relative to the first support 55 can generate the first control setpoint, for example in the form of an analog signal representative of the first control parameter.

Similarly, when the second piloting control 52 comprises a second movable member 57 having at least one degree of rotational mobility relative to the second support 58 about the second rotation axis X2, actuation of the second movable member 57 can generate the second control setpoint in the form of a calibrated pulsed signal representative of the second control parameter. The second control setpoint can thus be used to modify the control order precisely by a predetermined increment.

The first setpoint can be determined as a function of a current position of the first movable member 54 relative to the first support 55. The first setpoint can thus vary in a linear or non-linear manner with such a current position of the first movable member 54.

In addition, the first setpoint may vary according to different variation laws as a function of a flight parameter such as, for example, the ground or air speed of the compound rotorcraft 1.

Alternatively, such a first piloting control 51 may be monostable. In this case and as shown in FIG. 3, the first piloting control 51 may comprise first elastic return means 56 configured to automatically return the first movable member 54 to a central position P1, after having been rotated. These first elastic return means 56 may comprise a spring under torsion, for example.

In addition, the first movable member 54 may, for example, be rotated by a finger of a pilot in two opposing directions of rotation S1 and S2 about a first central position P1.

The first movable member 54 may comprise a straight protrusion 154 that may, for example, project radially from a substantially cylindrical portion 155. Such a straight protrusion 154 allows the pilot's finger to bear on it in order to transmit torque to the first movable member 54, but also to serve as a sensory marker in order to identify the current position of the first movable member 54 relative to the first central position P1.

In this case, the first control setpoint can be determined as a function of a difference between a current position of the first movable member 54 and the first central position P1. Having approached a predetermined piloting target, the first movable member 54 can be released by the pilot and can thus return to its first central position P1 without modifying the first control setpoint.

The first setpoint can thus vary in a linear or non-linear manner with such a positional deviation of the first movable member 54.

In this case, the first setpoint may also vary according to different variation laws as a function of a flight parameter such as, for example, the ground or air speed of the compound rotorcraft 1.

Similarly, the second piloting control 52 may be monostable. In this case and as shown in FIG. 4, the second piloting control 52 may comprise second elastic return means 59 configured to return the second movable member 57 to the second central position P2. These second elastic return means 59 may comprise a spring under torsion, for example.

The second movable member 57 is thus capable of being rotated in two opposing directions of rotation S3 and S4 about a second central position P2.

The second movable member 57 may comprise a knob or a substantially concave face 157. Such a face 157 projects radially from a substantially cylindrical portion 158. Such a face 157 allows the pilot's finger to bear on it in order to move the second movable member 57 with respect to the second support 58.

Such a knob may have at least three discrete states, namely a first state referred to as beep+ requesting an increase in the second control setpoint, a second state referred to as beep− requesting a decrease in the second control setpoint, and a third state requesting no modification of the second control setpoint.

Furthermore, the second movable member 57 may also have a degree of translational mobility relative to the second support 58 along a translation axis Y2 perpendicular to the second rotation axis X2. In this case, the substantially cylindrical portion 158 may then be free to move inside a substantially straight groove 160.

In this case, the second piloting control 52 may comprise other elastic return means 159 such as a spring under compression. The elastic return means 159 are thus configured to automatically return the second movable member 57 to a rest position corresponding to the second central position P2.

In addition, in a particular control mode, the first control setpoint may be representative of a first control parameter determined according to a choice from at least two different control parameters; an actuation of the second piloting control 52 may then allow the choice of the first control parameter to be modified.

Moving the second movable member 57 in translation along the translation axis Y2 can then generate a selection of another parameter and therefore a modification of the initial choice corresponding to the first control parameter.

As shown in FIG. 5, the disclosure also relates to a control method 60 for controlling at least one propeller 10, 15 of the compound rotorcraft 1.

Such a control method 60 includes a step 61 of generating a first control setpoint and a step 62 of generating a second control setpoint different from the first control setpoint.

The control method 60 then comprises a step 63 of generating a control order for collectively controlling a pitch of the blades 11, 16 of the propeller or propellers 10, 15.

Such a step 63 of generating the control order is then carried out depending on the first control setpoint and the second control setpoint by implementing a control law generating the control order as a function of the first control setpoint and the second control setpoint.

For example, the control law implemented during the step 63 of generating the control order makes it possible to combine the first control setpoint and the second control setpoint with each other.

The first control setpoint can thus be modified with a first increment in order to allow a piloting target to be approached rapidly. The second control setpoint may be modified with a second increment that is smaller than the first increment in order to allow the predetermined piloting target to be reached in a precise manner.

Furthermore, the control law implemented during the step 63 of generating the control order may be a function, for example, of the forward air or ground speed of the compound rotorcraft 1. More precisely, the first increment and/or the second increment are linearly or non-linearly variable as a function of this forward speed of the compound rotorcraft 1.

Naturally, the present disclosure is subject to numerous variations as regards its implementation. Although several embodiments are described above, it should readily be understood that it is not conceivable to identify exhaustively all the possible embodiments. It is naturally possible to envisage replacing any of the means described by equivalent means without going beyond the ambit of the present disclosure.

What is claimed is:

1. A control system for controlling at least one propeller of a compound rotorcraft, the control system generating a control order for collectively controlling a pitch of the blades of the at least one propeller,
the control system including:
a first piloting control for generating a first control setpoint;
a second piloting control for at least generating a second control setpoint different from the first control setpoint; and
a control unit configured to generate the control order depending on the first control setpoint and the second control setpoint, the control unit implementing a control law generating the control order as a function of the first control setpoint and the second control setpoint,
wherein the first control setpoint is representative of a first control parameter and the second control setpoint is representative of a second control parameter corresponding to a primitive of the first control parameter.

2. The control system according to claim 1
wherein the first piloting control includes a first movable member having at least one degree of rotational mobility relative to a first support about a first rotation axis, the first movable member being capable of being rotated in two opposing directions of rotation about a first central position.

3. The control system according to claim 2
wherein the first piloting control is monostable, the first piloting control including first elastic return means configured to return the first movable member to the central position.

4. The control system according to claim 1
wherein the second piloting control includes a second movable member having at least one degree of rotational mobility relative to a second support about a second rotation axis, the second movable member being capable of being rotated in two opposing directions of rotation about a second central position.

5. The control system according to claim 4
wherein the second piloting control is monostable, the second piloting control including second elastic return means configured to return the second movable member to the second central position.

6. The control system according to claim 4
wherein the second movable member has a degree of translational mobility relative to the second support along a translation axis, the translation axis being oriented perpendicular to the second rotation axis.

7. The control system according to claim 1
wherein the first control setpoint is representative of a first control parameter chosen from the group comprising a ground speed of the compound rotorcraft, an air speed of the compound rotorcraft, a longitudinal acceleration of the compound rotorcraft relative to the ground, a first time derivative of the longitudinal acceleration of the compound rotorcraft relative to the ground, a second time derivative of the longitudinal acceleration of the compound rotorcraft relative to the ground, a speed of variation of a power transmitted to the at least one propeller and a speed of variation of the pitch of the blades of the at least one propeller.

8. The control system according to claim 1
wherein, the second piloting control including a second movable member having at least one degree of rotational mobility relative to a second support about a second rotation axis, pulsed actuation of the second movable member according to the at least one degree of rotational mobility relative to the second support generates the second control setpoint in the form of a calibrated signal representative of the second control parameter.

9. The control system according to claim 8
wherein the second control setpoint is generated by integrating the variations of the first control parameter over a time interval defined by a duration of actuation of the second piloting control.

10. The control system according to claim 1
wherein the first control setpoint is representative of a first control parameter determined according to a choice from at least two different control parameters, an actuation of the second piloting control is configured to modify the choice of the first control parameter.

11. The control system according to claim 10
wherein, the second movable member having a degree of translational mobility relative to the second support along a translation axis, moving the second movable member along the translation axis modifies the choice of the first control parameter.

12. The control system according to claim 1
wherein the first piloting control and the second piloting control are arranged on a handle of a collective pitch control stick, the collective pitch control stick enabling to collectively control a pitch of the blades of a lift rotor of the compound rotorcraft.

13. The control system according to claim 1
wherein the first piloting control and the second piloting control are separate from each other.

14. A compound rotorcraft including at least one propeller,
wherein the compound rotorcraft includes the control system according to claim 1.

15. A control method for controlling at least one propeller of the compound rotorcraft, the control method including a step of generating a control order for collectively controlling a pitch of the blades of the at least one propeller,
the control method including the following steps:
generating a first control setpoint; and
generating a second control setpoint different from the first control setpoint,
the step of generating the control order being carried out depending on the first control setpoint and the second control setpoint, by implementing a control law generating the control order as a function of the first control setpoint and the second control setpoint,
wherein the first control setpoint is representative of a first control parameter and the second control setpoint is representative of a second control parameter corresponding to a primitive of the first control parameter.
